(19) United States
(12) Patent Application Publication
(10) Pub. No.: US 2024/0265171 A1
(43) Pub. Date: Aug. 8, 2024

(54) IMPRINT-BASED MESH GENERATION FOR COMPUTER-AIDED DESIGN (CAD) OBJECTS

(71) Applicant: Siemens Industry Software Inc., Plano, TX (US)

(72) Inventor: Nilanjan Mukherjee, Cincinnati, OH (US)

(73) Assignee: Siemens Industry Software Inc., Plano, TX (US)

(21) Appl. No.: 18/565,332

(22) PCT Filed: Jun. 16, 2021
(86) PCT No.: PCT/US2021/037651

§ 371 Date: Nov. 29, 2023

(51) Int. Cl. G06F 30/23; G06T 17/20

(52) U.S. Cl. CPC G06F 30/23; G06T 17/205

(57) ABSTRACT

A computing system may include a computer-aided design face access engine configured to access a CAD object and an imprint-based meshing engine configured to define an imprint region for a face of the CAD object and decompose the face into virtual faces, including an imprinted virtual face and a remainder virtual face. The imprint-based meshing engine may also be configured to mesh the imprinted virtual face, mesh the remainder virtual face, and merge the imprint region mesh and the remainder region mesh together to form an output mesh, including by extending a portion of the imprint region mesh into the remainder portion of the face or extending a portion of the remainder region mesh into the imprint region.

### BACKGROUND

Computer systems can be used to create, use, and manage data for products, items, and other objects. Examples of computer systems include computer-aided design (CAD) systems (which may include computer-aided engineering (CAE) systems), visualization and manufacturing systems, product data management (PDM) systems, product lifecycle management (PLM) systems, and more. These systems may include components that facilitate the design, visualization, and simulated testing of product structures and product manufacture.

### BRIEF DESCRIPTION OF THE DRAWINGS

Certain examples are described in the following detailed description and in reference to the drawings.

FIG. 1 shows an example of a computing system that supports imprint-based mesh generation according to the present disclosure.

FIG. 2 shows an example imprint-based meshing through circle shapes imprinted on to a CAD face.

FIG. 3 shows an example imprint-based meshing through a box-with-hole shape imprinted on to a CAD face.

FIG. 4 shows an example of an output mesh generated according to the present disclosure for a CAD face that includes face interior holes.

FIG. 5 shows an example orientation of imprint regions to a mesh direction.

FIG. 6 shows an example orientation of mesh elements of a mesh design to align to a mesh direction of a CAD face.

FIG. 7 shows an example of an output mesh in which mesh elements that surround face interior holes align with a mesh direction specified for a CAD face.

FIG. 8 shows an example of logic that computing system may implement to support imprint-based mesh generation.

FIG. 9 shows an example of a computing system that supports imprint-based mesh generation.

### DETAILED DESCRIPTION

With technological advancements in CAD computing systems, the capabilities of CAD-based design, simulation, and processing of CAD models are increasing as well. Complex simulations can be performed to test nearly any aspect, characteristic, or behavior of CAD objects that digitally model physical products. CAE systems may, for example, provide finite element analysis (FEA)-based simulation suites that can implement complex and robust simulation features for a vast variety of tests on nearly any type of product. Example simulation scenarios supported by modern CAE systems range from thermal simulations of gas turbine components, to pressure measurements for composite ply-layup procedures, to complex fluid dynamics simulations, to detailed impact simulations of car parts in vehicular crashes.

FEA simulation suites typically rely on an underlying mesh to drive simulation capabilities. A mesh may be comprised of mesh elements that together cover the surface (or volume) of a CAD model, forming the mesh. Mesh elements may have various characteristics, shapes, and parameters, with specific mesh element attributes depending on the meshing process used to generate the mesh. For instance, mesh elements can be triangular, quadrilateral, or hexahedral in shape, as but a few examples. As used herein, meshing may refer to any process, procedure, computation, or flow that generates a mesh. Modern meshing technologies have continued to increase in complexity, and mesh model preparation processes have become increasingly specialized. Geometry preparation and simplification for meshing and mesh generation technologies have faced challenges with scalability and variability. In a similar manner that geometric representations cannot be over-simplified without impacting FEA simulation accuracy, a single surface meshing algorithm may be insufficient to satisfy analysis accuracy demands across a variety of types of object models and simulation scenarios.

Various types of structural analysis and other FEA simulations for 3D models require high-quality meshes to accurately analyze a CAD model. For example, stress analyses in 3D models often analyze deflections, cracking, and stress points at specific (e.g., critical) regions of a 3D object, for example at holes, nut and bolt locations, sheet cut outs, etc. Having high quality mesh elements at such locations may be imperative to ensure proper structural analyses. As another example, collision analyses in the automotive industry may be performed on a discretized finite element mesh model of the entire car assembly, especially through what is called the body-in-white (BIW). In the automotive industry, BIW may refer to the fabricated (usually seam and/or tack welded) sheet-metal components that form the body of a car. As such, BIW models may represent a stage of the car body prior to painting and before the moving parts (doors, hoods, fenders etc.), the engine, chassis sub-assemblies, and trim (glass, seats, upholstery, electronics, etc.) have been mounted. Structured and regular quadrilateral-dominant meshes (with the majority face interior nodes connected to four elements, e.g., possess a valency of 4) can be created to represent BIW body panels for testing car behavior through a variety of finite element analyses and simulations.

Collision analyses on such BIW models is usually a nonlinear, transient dynamic structural analysis for a mesh under shock and/or impact loading. Such detailed analyses can be performed in order to predict the stress, deflection and rupture of the automobile in a crash situation. For results and predictions to be accurate, collision analyses may require the finite element mesh to have many distinct characteristics, namely, high-quality structured mesh elements for BIW features and around bolt holes. Generation of such high-quality structured meshes, especially at critical locations of a CAD object, can be challenging. Conventional meshing algorithms uniformly applied across an entire CAD object may be incapable of generating mesh elements of sufficient quality at critical regions of the CAD model, and such-generated meshes may often be insufficient for FEA processes to test a 3D object with the required accuracy.

Some techniques exist to alter the geometry of the CAD object itself, introducing additional geometric faces that directly represent critical regions of a CAD model. Geometry operators of a geometry engine can alter the geometry of a CAD model for the purpose of mesh generation. For instance, CAD-oriented geometry operations can splice or insert geometric faces into a CAD object to represent a critical region or other region-of-interest. However, such geometry alteration-based meshing techniques are hindered by various limitations and challenges. As an example limitation, representation of critical regions through CAD geometry (e.g., a CAD face) requires dimension-fitting to a specific mesh element size. That way, the inserted geometric face can align with mesh element boundaries in an attempt to smooth mesh transitions between the faces of the CAD object. Any resizing of mesh elements (e.g., to a different mesh dimension, area, or granularity) may require a complete redesign of the geometry faces used to represent critical regions, resulting in excess computations, latency, and resource requirements for even minimal mesh changes.

As meshing can be a complex process that requires multiple iterations or generation of multiple candidate mesh models to identify high-quality meshes, such re-insertion of geometric faces to represent critical regions (required for any mesh parameter change) can result in increased processing times and resource consumption. Such limitations and extraneous computing times may render mesh generation latencies so high so as to make such processes untenable in modern CAD contexts. Moreover, geometric representations of critical regions may be impaired by mesh smoothing limitations in that the CAD face boundaries of the critical region are fixed. Thus, smoothing algorithms to increase quality of mesh elements may be incapable of fully smoothing mesh elements proximate to boundaries between critical regions and non-critical regions of a CAD model. Such limitations may reduce and limit the quality of generated meshes, which may then reduce FEA simulation capabilities and accuracy as well.

The disclosure herein may provide systems, methods, devices, and logic for imprint-based mesh generation. As described in greater detail, the imprint-based meshing technology disclosed herein may provide capabilities to imprint shapes on to faces of CAD model and treat such imprinted shapes as distinct meshing zones within the same CAD face. By decomposing a single CAD face into multiple regions (e.g., multiple virtual faces), the imprint-based meshing technology of the present disclosure may allow for customizable meshing at critical regions of a CAD face, for example using meshing parameters to generate finer-sized mesh elements or mesh elements of higher quality than those meshed at other non-critical regions. Such imprint-based meshing may be possible without altering the actual geometry of a CAD object, as such geometric operations can incur significant computational costs as compared to local imprinting and zoning of CAD faces of the imprint-based meshing technology described herein. As imprint-based meshing can be implemented to be native to the meshing logic of a CAD application, the features of the present disclosure can be implemented without any additional user-specified CAD operations or geometric alterations, as the imprinting and meshing of imprint regions can be performed seamlessly and flexibly as part of an overall meshing process.

These and other features of the imprint-based meshing technology and the technical benefits of the present disclosure are described in greater detail herein.

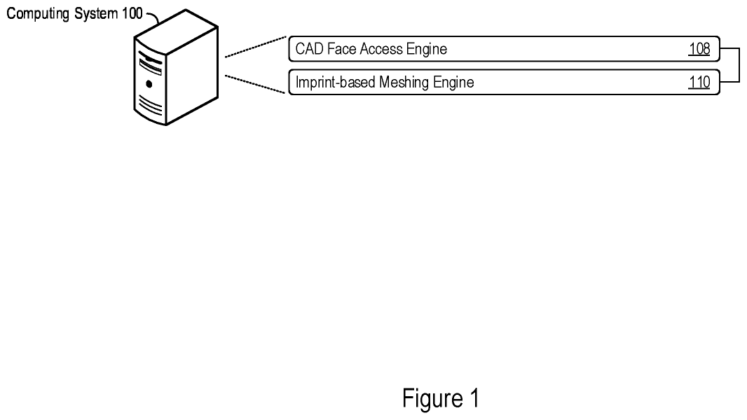

FIG. 1 shows an example of a computing system 100 that supports imprint-based mesh generation. The computing system 100 may take the form of a single or multiple computing devices such as application servers, compute nodes, desktop or laptop computers, smart phones or other mobile devices, tablet devices, embedded controllers, and more. In some implementations, the computing system 100 hosts, supports, executes, or implements a CAD application that provides any combination of mesh generation and processing capabilities.

As an example implementation to support any combination of the imprint-based meshing features described herein, the computing system 100 shown in FIG. 1 includes a CAD face access engine 108 and a imprint-based meshing engine 110. The computing system 100 may implement the engines 108 and 110 (including components thereof) in various ways, for example as hardware and programming. The programming for the engines 108 and 110 may take the form of processor-executable instructions stored on a non-transitory machine-readable storage medium and the hardware for the engines 108 and 110 may include a processor to execute those instructions. A processor may take the form of single processor or multi-processor systems, and in some examples, the computing system 100 implements multiple engines using the same computing system features or hardware components (e.g., a common processor or a common storage medium).

In operation, the CAD face access engine 108 may access a CAD object, for example by loading or opening a 3D model or any other CAD file or 3D design. In operation, the imprint-based meshing engine 110 may define an imprint region for a face of the CAD object and decompose the face into virtual faces, including an imprinted virtual face that covers the imprint region and a remainder virtual face that covers a remainder portion of the face outside of the imprint region. Note that the imprint-based meshing engine 110 may decompose the face into virtual faces without altering the underlying geometry of the CAD object (and the face thereof). These virtual faces may represent separate partitions or zones that are part of the same face of the CAD object. The imprint-based meshing engine 110 may then mesh the imprinted virtual face to form an imprint region mesh and mesh the remainder virtual face to form a remainder region mesh. The imprint-based meshing engine 110 may further merge the imprint region mesh and the remainder region mesh together to form an output mesh, including by extending a portion of the imprint region mesh into the remainder portion of the face, extending a portion of the remainder region mesh into the imprint region, or a combination of both.

In that regard, the imprint-based meshing engine 110 may smooth the imprint region mesh and the remainder region mesh such mesh elements of either of these meshes may extend into the imprint region or the remainder region. As the imprint region and remainder region are not defined as separate geometric faces of the CAD object, the imprint-based meshing engine 110 may smooth the meshes without being limited by fixed face boundaries. Explained in a different way, imprinted region boundaries defined by imprinted shapes need not serve as boundary limitations in the smoothing of mesh elements of an output mesh. As such, the imprint-based meshing engine 110 can produce smoother transitions and higher-quality mesh elements between the imprint region mesh and the remainder region mesh to form an output mesh for the face of the CAD object, especially as compared to geometry-based techniques incapable of smoothing between CAD face boundaries.

The imprint-based meshing technology presented herein may be implemented as part of or local to the meshing capability of a CAD application, and as such may be implemented as part of the design and architecture of a meshing component of a CAD application to support shape imprinting on CAD faces. In that regard, the imprint-based meshing technology may subdivide or partition a CAD face into multiple zones (also referred to as virtual faces) by imprinting shapes onto the CAD face that define the different regions to mesh in a CAD face. Many examples of the present disclosure are presented using the imprint-based meshing engine 110 as an illustrative implementation. However, any viable implementation of the imprint-based meshing technology is contemplated herein.

As a general overview, the imprint-based meshing engine 110 may identify a face of a CAD object as a face of interest, and imprint shapes onto the CAD face to partition the CAD face into different meshing zones. In support of such shape imprinting, the imprint-based meshing engine 110 may determine a particular shape to imprint onto the CAD face, which the imprint-based meshing engine 110 may select based on default meshing parameters or via user specifications. Then, the imprint-based meshing engine 110 may orient the shape onto the CAD face, for example to align with a mesh direction specified for the CAD object (e.g., a collision direction specified for automotive meshes). Next, the imprint-based meshing engine 110 may imprint the selected shape at a specified location on the CAD face, and in doing so may adjust the size of the shape according to any number of mesh control parameters (e.g., mesh element sizes, dimensions, etc.).

In imprinting the shape onto the face, the imprint-based meshing engine 110 may create virtual vertices, virtual edges, and virtual faces to represent the shape on the CAD face. For example, the imprint-based meshing engine 110 may utilize surface decomposers or mesh topology operators to create the virtual faces. As such, each imprinted shape may be represented as a virtual face, and the residual area aside from the virtual faces (a non-imprinted or remainder region) becomes another boolean virtual face. A virtual topology may thus be built by the imprint-based meshing engine 110. These virtual topologies may be comprised of points and lines, and as such do not involve facets and tessellations. Put another way, the imprint-based meshing engine 110 may imprint and decompose a CAD face to form virtual faces that are not separate CAD geometries (not separate CAD faces), but rather lines, curves, and points to mark out sub-regions of a CAD face in its 2D parameter space. The imprint-based meshing engine 110 may represent and define imprint regions and virtual faces to follow a strict Eulerian topological system of definitions and operations.

Through the various virtual faces constructed for a given CAD face, the imprint-based meshing engine 110 may mesh the various virtual faces with different meshing parameters, flexibly allowing finer meshing or stricter mesh control parameters to be used for specific zones of a CAD face (e.g., critical regions). The imprint-based meshing engine 110 may, in some sense, separately mesh the different zones of a CAD face, e.g., by generating separate meshes for imprinted regions delineated by the imprint virtual faces and a remainder region that is outside of the imprinted shapes. As the virtual faces are not separately delineated geometric faces of CAD object, the imprint-based meshing engine 110 may smooth these separate meshes together without boundary constraints between the imprint and remainder regions of the CAD face, which may thus increase mesh quality at these transition boundaries. As such, the imprint-based meshing engine 110 may provide meshing capabilities to distinctly mesh different zones of the same CAD face.

These and other imprint-based meshing features and technical benefits are described in greater detail next. Many of the examples presented herein use shape imprinting onto a 2D parameter space of a CAD face as an illustrative example (and 2D imprinting, decomposing, and/or meshing can then be transformed into a 3D model). However, the present disclosure is not so limited, and any of the imprint-based meshing technology may be consistently implemented directly for 3D faces of a CAD object.

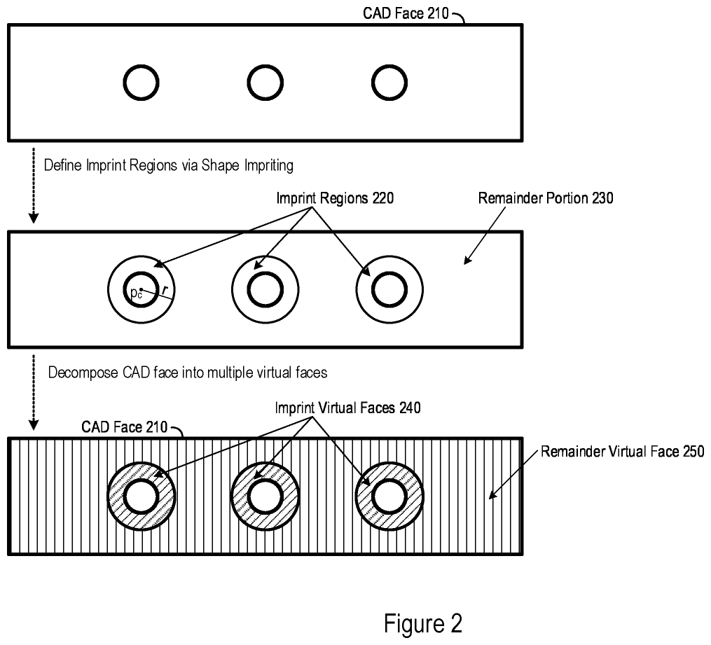

FIG. 2 shows an example imprint-based meshing through circle shapes imprinted on to a CAD face. Imprinting circular shapes in the 2D domain of a CAD face can serve as an elegant way to zone out areas-of-interest in order to refine a mesh in the zoned areas for more accurate analysis. The imprint-based meshing engine 110 may imprint shapes on to a CAD face according to any number of imprint parameters. As examples, imprint parameters may specify a location of a CAD face to imprint a shape, a shape type (e.g., circular, box, conic, etc.), a shape size, or any other parameter that defines any aspect of shape imprinting.

For imprinting a circular shape on to a CAD face, the imprint-based meshing engine 110 may identify, as imprint parameters, a centroid of the circular imprint (which may take the form of a point specifying a circle center), a shape type specifying a circle shape, and a radius value to define a size of the circle shape to imprint. In the example shown in FIG. 2, the imprint-based meshing engine 110 may identify a CAD face 210 as a face-of-interest of a CAD object (e.g., via user selection) and imprint three (3) circle shapes around holes of the CAD face 210. As seen in FIG. 2, an imprinted circle shape can be defined by a center point labeled as “pc” and a radius “r”, and the imprint-based meshing engine 110 may imprint the circle shape through a circular curve on to the CAD face 210. As noted herein, imprinting the circle shapes onto the CAD face 210 may be performed by the imprint-based meshing engine 110 as part of a meshing process. Thus, the imprinted circles may delineate different regions of the CAD face 210, but the geometric representation of the CAD face 210 remains a single face.

By imprinting shapes onto the CAD face 210, the imprint-based meshing engine 110 may define imprint regions 220. Each imprint region of the imprint regions 220 may define a different “area-of-interest” via a respective imprinted circle shape and hole border of the CAD face 210. That is, through shape imprinting on to the CAD face 210 of three (3) circle shapes, the define different zones or partitions of the CAD face 210 as the imprint regions 220. Note that by defining imprint regions 220 via shape imprinting, the imprint-based meshing engine 110 may (at least implicitly) define a remainder portion 230 as well, which may refer to any portion of the CAD face 210 that is not part any imprint region defined by shapes imprinted on to the CAD face 210. The imprint-based meshing engine 110 may, in some cases, define or determine the remainder portion 230 as a boolean between the CAD face 210 and the defined imprint regions 220, with the remainder portion 230 determined as any portion of the CAD face 210 not defined as an imprint region 220.

The imprint-based meshing engine 110 may decompose, into virtual faces) the various regions of the CAD face 210 defined by imprinted shapes. In that regard, the imprint-based meshing engine 110 may virtually decompose the CAD face 210 (for the purpose of meshing) into multiple virtual faces. Decomposition of a CAD face 210 may include any computation, step, or process by which the imprint-based meshing engine 110 separates the imprint regions 220 and the remainder portion 230 into different logical entities that are subsequently processed. For example, the imprint-based meshing engine 110 may decompose the CAD face 210 of FIG. 2 into the imprint virtual faces 240 and the remainder virtual face 250, which may respectively correspond to the imprint regions 220 and remainder portion 230 defined by imprinting the circle shapes onto the CAD face 210.

The virtually decomposed faces of a CAD face may be referred to as “virtual faces” in that they are not separate geometric faces in a CAD object. Instead, the imprint virtual faces 240 and the remainder virtual face 250 may be separate zones or partitions in the same CAD face 210. Virtual decomposition may thus be performed by the imprint-based meshing engine 110 without use of CAD geometric operations that alter the underlying geometry of a CAD object (e.g., without altering a geometric NURBS-based representation of a CAD object). As such virtual decomposition may be performed by the imprint-based meshing engine 110 during meshing or as an implemented feature of a meshing engine, such shape imprinting/imprint region definition and virtual face decomposition may be a process localized to the meshing of CAD objects.

Decomposition into virtual faces may, in some implementations, be performed by differentiating the imprint virtual faces 240 and the remainder virtual face 250 in meshing of the CAD face 210. For example, the imprint-based meshing engine 110 may provide the imprint virtual faces 240 as inputs into a different meshing process (e.g., performed with different meshing parameters) than a meshing process used to mesh the remainder virtual face 250. Virtual decomposition may thus include inputting the imprint virtual faces 240 to a local meshing process configured with local meshing parameters specific to interest regions surrounding the holes of the CAD face 210 and inputting the remainder virtual face 250 to a global meshing process configured with global meshing parameters applicable generally to the CAD face 210 or globally applicable to meshing of a CAD object.

Accordingly, the imprint-based meshing engine 110 may mesh the imprint virtual faces 240 differently than the remainder virtual face 250. The imprint-based meshing engine 110 may mesh the imprinted virtual faces 240 to form an imprint region mesh and mesh the remainder virtual face 250 to form a remainder region mesh. Such meshing processes may differ in that different mesh control parameters are applied in the differentiated meshing of the imprint virtual faces 240 and the remainder virtual face 250. In some implementations, the imprint-based meshing engine 110 may mesh the imprinted virtual faces 240 at a finer mesh element size than the meshing of the remainder virtual face 250. In some implementations, the imprint-based meshing engine 110 may mesh the imprinted virtual faces 240 at a local mesh element size specified for the imprint regions 220 and, in contrast, mesh the remainder virtual face 250 at a global mesh element size specified for a global meshing process for the CAD object (which includes the CAD face 210). These are but a few examples of different mesh control parameters that the imprint-based meshing engine 110 may apply to separately mesh imprint virtual faces and a remainder virtual face of a CAD face 210, and any suitable difference in meshing the imprint virtual faces and remainder virtual faces are contemplated herein.

As the imprint-based meshing engine 110 may mesh the imprint virtual faces 240 differently from the remainder virtual face 250, generated imprint region meshes and a remainder region mesh may be understood as logically separate meshes. To form an output mesh for the CAD face 210, the imprint-based meshing engine 110 may merge the imprint region meshes together with the remainder region mesh, for example through any suitable mesh boolean or mesh joining operation. In merging the imprint region meshes and remainder region mesh, the imprint-based meshing engine 110 may perform any type of mesh smoothing process for mesh elements that will together form the output mesh.

Note that since the imprint region meshes and remainder region mesh are not defined by separate geometric faces of a CAD object, the imprint-based meshing engine 110 may smooth the imprint region meshes and remainder region mesh without being expressly limited by boundaries between the imprint regions 220 and the remainder portion 230. In such smoothing, the imprint-based meshing engine 110 may adjust mesh elements of imprint region meshes, a remainder region mesh, or combinations of both by adjusting node locations to conform mesh elements to ideal mesh element shapes or otherwise to smooth out transitions between the imprint region mesh and the remainder region mesh.

For instance in FIG. 2, the imprint-based meshing engine 110 may merge imprint region meshes and the remainder region mesh together to form an output mesh by extending a portion of the imprint region mesh into the remainder portion of the CAD face 210, by extending a portion of the remainder region mesh into the imprint region 220, or a combination of both. As mesh smoothing in forming output meshes is not strictly confined by geometric face boundaries, smoothing of an output mesh generated from the imprint region meshes and the remainder region mesh may produce higher-quality mesh elements, which may in turn result in higher quality meshes for FEA simulations.

Note that the output mesh generated by the imprint-based meshing engine 110 can smooth mesh elements of imprinted region meshes to locations outside of an imprint region or smooth mesh elements of a remainder region mesh to locations into imprint regions. Such an output mesh would not be possible for conventional meshing processes that delineate zones of interest via geometric CAD operators. Modifying a CAD geometry to insert geometric faces that represent interest regions would necessarily confine meshing processes to the CAD face boundaries specified through such CAD geometry-based delineations of a CAD object. On the other hand, the imprint-based meshing technology of the present disclosure may overcome such meshing limitations through shape imprinting during the meshing process itself, allowing the imprint-based meshing engine 110 to smooth generated imprint region meshes together with a remainder region mesh without boundary limitations and with increased efficiency and capability. As such, the imprint-based meshing technology described herein may support localized meshing for areas-of-interest in a CAD face with increased meshing flexibility and smoothing capabilities.

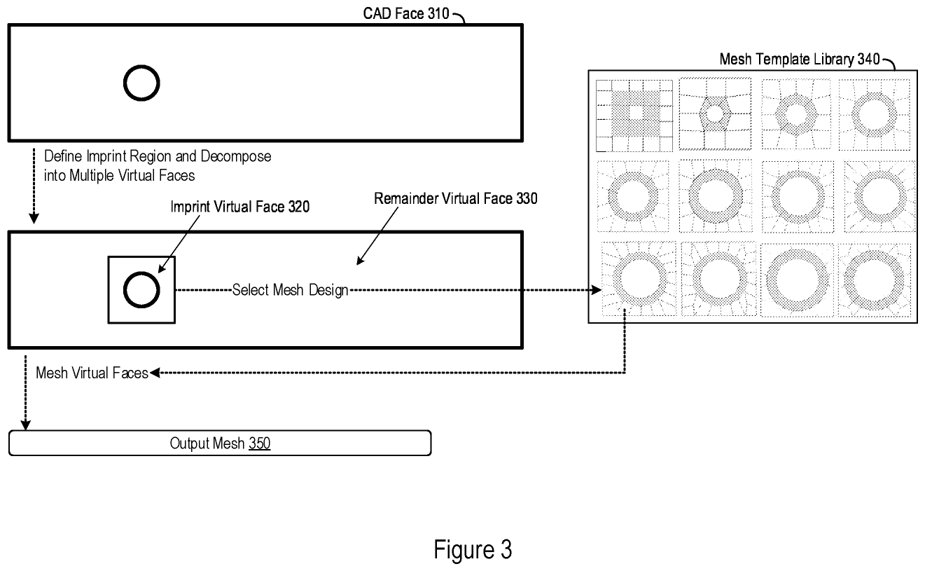

Another example type of imprint shape supported by the imprint-based meshing technology of the present disclosure is presented next with reference go FIG. 3.

FIG. 3 shows an example imprint-based meshing through a box-with-hole shape imprinted on to a CAD face. Holes located within a CAD face may be referred to as face interior holes, and areas of a CAD face surrounding face interior holes may be regions of high interest in structural analyses. Structural joining and fastening of CAD objects often occur at face interior holes. For example, joints and fasteners like bolts, rivets, pins, locks may pass through these holes to join multiple elements of a CAD object together. As another example, power and energy transfers and load bearing members (e.g., shafts, rods etc.) may be lodged at face hole interior holes, which may make such locations potential areas of catastrophic stress, part failure, and long-term crack initiations.

As such, it can be a goal in mesh creation to target areas of interest around face interior holes and ensure that a generated mesh is regular and structured near such face interior holes. It is often a goal in mesh creation that mesh elements proximate to face interior holes deviate minimally from their ideal shapes, e.g., as measured by mesh element-included angles—60° for triangular mesh elements, 90° for quadrilateral mesh elements, etc. Shape imprinting that creates a box-shape around face interior holes of a CAD face can support generation of well-patterned mesh. Such functionality may be of particular interest and importance to structural engineers, and particularly so for automotive crash analysts since weldments, fasteners, bolts and other joining locations may be highly susceptible elements during car collisions. During finite element analysis, great care may be taken to reduce analysis error in these high-interest areas. Consequently, the shape and nature of the portions of a quadrilateral-dominant mesh (for example) that surround face interior holes may assume increased importance and be identified as high-interest regions of a CAD face.

In the example shown in FIG. 3, the imprint-based meshing engine 110 may identify a CAD face 310 as a face-of-interest of a CAD object (e.g., via user selection) and imprint a box-with-hole shape around a face interior hole of the CAD face 310. The imprint-based meshing engine 110 may imprint a box-with-hole shape on to the CAD face 310 according to any number of imprint parameters, such as a box location on the CAD face 310 to imprint the shape, a shape type specifying a box-with-hole (or box) shape, a shape size value, or any other parameter that defines any aspect of imprinting a box-with-hole shape on to the CAD face 310. The imprint-based meshing engine 110 may, in some implementations, imprint a box-with-hole shape by imprinting a box shape (via topological nodes, linear edges, etc.) onto the CAD face 310. In some implementations, the imprint-based meshing engine 110 may further imprint a circular curve to represent the hole in the box-with-hole shape (though such hole imprinting is not necessarily required). Accordingly, the imprint-based meshing engine 110 may imprint a box shape surrounding the face interior hole of the CAD face 310 in FIG. 3.

By imprinting a box-with-hole shape onto the CAD face 310, the imprint-based meshing engine 110 may define an imprint region that surrounds the face interior hole. Then, the imprint-based meshing engine 110 may decompose the CAD face 310 into multiple virtual faces, including the imprint virtual face 320 and the remainder virtual face 330 shown in FIG. 3. Virtual decomposition may include separating the imprint region defined by the imprinted box shape and a remainder portion of the CAD face 310 into separate logical entities to mesh differently.

Through box-with-hole imprinting, the imprint-based meshing engine 110 may define the imprint region as a box-with-hole type of imprint region. In meshing the imprinted the imprinted virtual face 320 decomposed from such an imprint region, the imprint-based meshing engine 110 may select a mesh design from a mesh template library 340 in order to mesh the imprinted virtual face 320. The goal of templatizing a mesh inside a box-with-hole imprint region and decomposed virtual face (e.g., the imprinted virtual face 320) may be to control element connectivity or other mesh element quality aspects for the meshing of the box-with-hole virtual face.

The mesh template library 340 may take the form of any set of mesh designs. The mesh designs specified in the mesh template library 340 may be specifically designed for different scenarios, CAD face types, face interior hole characteristics, or any other relevant factors. Mesh designs of the mesh template library 340 may also be specific to particular mesh processes and mesh types, e.g., generation of quadrilateral-dominant meshes.

For instance, quadrilateral-dominant meshes may be used in automotive structural analyses, and BIW crash analyses may require that mesh elements satisfy a set of quality criteria. As an illustrative example, the quality criteria may specify a maximum quadrilateral element angle (e.g., αₘₐₓ<150°), a minimum quadrilateral element angle ((e.g., αₘᵢₙ>30°), a threshold Jacobian ratio for mesh elements (e.g., >0.48), a threshold skew value (e.g., passes a solver threshold), and the like. The imprint-based meshing engine 110 may implement, produce, access, or otherwise include mesh designs as part of the mesh template library 340 that satisfy any number of quality criteria for meshes, and for various different design parameters.

As an example implementation, the imprint-based meshing engine 110 may design, configure, sort, or categorize mesh designs of the mesh template library 340 based on design parameters that include a number of mesh elements that surround a face interior hole (e.g., 4-20), a hole orientation (e.g., parallel, perpendicular, other), a parity of element type (e.g., divisible by 4, even, odd), quad dominance indicator (e.g., all quadrilateral elements, quadrilateral dominant, triangular), mesh template or mesh algorithm identifier.

A given mesh design in the mesh template library 340 may be comprised of multiple layers of mesh elements that surround a face interior hole. In some specific implementations, mesh designs are made up of two layers of mesh elements, a paver layer of mesh elements (also referred to as a paver ring) and outer layer of mesh elements (also referred to as an outer ring). At least one layer of mesh elements in a mesh design may border the box boundary of a box-with-hole shape. For mesh designs comprised of two layers, then outer ring may border the box shape, and thus mesh element shapes and boundaries may be controlled based on the box boundary (at least prior to smoothing). Each mesh design may be represented as a pattern with a fixed set of mesh elements positioned in a preconfigured manner. In creating mesh designs, paver rings may be generated by the imprint-based meshing engine 110 to surround face interior holes through any viable paving algorithm. Output rings may be created via template meshing design.

Accordingly, the imprint based meshing engine 110 may utilize mesh designs of a mesh template library 340 to mesh an imprint region defined by an imprinted box over a face interior hole. In the example of FIG. 3, the imprint-based meshing engine 110 may mesh the imprint virtual face 320 through selection and use of a mesh design of the mesh template library 340. Consistent with the imprint-based meshing technology described herein, the imprint-based meshing engine 110 may mesh the remainder virtual face 330 through a global meshing process or any number of global meshing parameters. Then, the imprint-based meshing engine 110 may form an output mesh 350 for the CAD face 310, e.g., by smoothing remainder region mesh generated for the remainder virtual face 330 with the imprint region mesh produced through a selected mesh design of the mesh template library 340. Generation of the output mesh 350 for the CAD face 310 may include smoothing mesh elements proximate to the face interior hole, including mesh elements of the generated imprint region mesh, the remainder region mesh, or combinations of both.

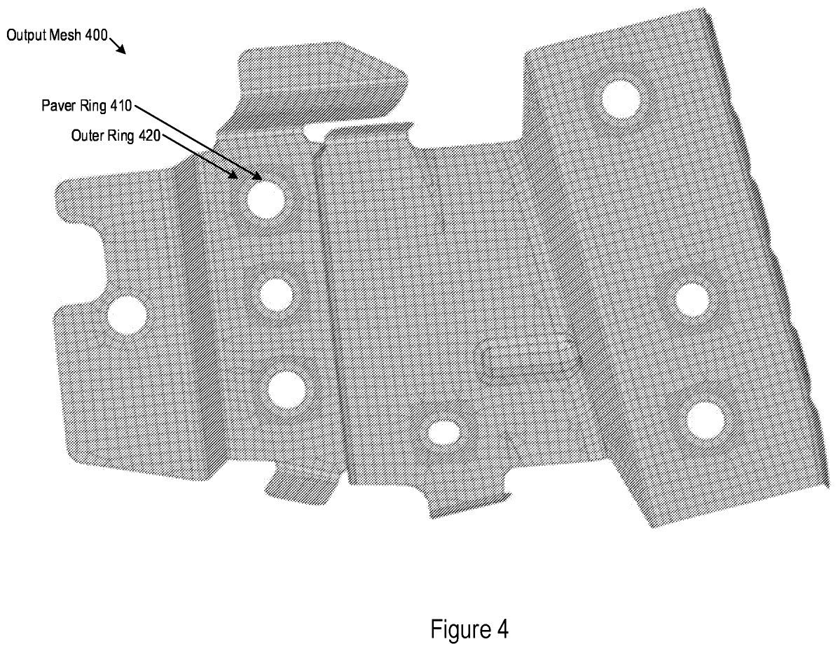

FIG. 4 shows an example of an output mesh 400 generated according to the present disclosure for a CAD face that includes face interior holes. In the example of FIG. 4, the imprint-based meshing engine 110 may generate the output mesh 400 by selecting a mesh design for meshing the imprint regions defined for the face interior holes of a CAD face. In particular, the imprint-based meshing engine 110 may select a mesh design with layers of mesh elements, including a paver ring 410 of mesh elements that surround a given face interior hole and an outer ring 420 that surrounds the paver ring 410 and borders the box boundary of an imprinted box shape.

As noted herein, the boundary of an imprinted shape in a CAD face need not pose a boundary limitation on mesh smoothing for generation of an output mesh. As such, in the output mesh 400 of FIG. 4, the outer ring 420 of a given mesh design selected for meshing an imprint virtual face may be smoothed such that mesh elements of the given mesh design extend beyond the boundary of the imprinted box shape. Through such smoothing, increasingly patterned and higher-quality mesh elements can be generated for the output mesh 400, which may increase the quality of FEA-based structural simulations using the output mesh 400. Such quality of mesh elements and patterned/structured mesh elements would not be possible with geometric-based CAD operations that specify interest regions via CAD geometry, since the face boundaries of inserted CAD faces would serve as boundary limitations in the meshing of such a CAD face.

In some cases, meshing of a CAD object may include specifying a mesh direction (also referred to as a mesh flow direction). The mesh direction may refer to a direction (e.g., vector) along which mesh elements are aligned. To support mesh direction-based meshing, the imprint-based meshing engine 110 may generate output meshes in which the meshing of defined imprint regions and decomposed imprint virtual faces produces mesh elements aligned along the direction. As such, the imprint-based meshing engine 110 may define imprint regions (at least in part) by orienting the imprint regions to a mesh direction specified for the CAD object, example features of which are discussed in greater detail next.

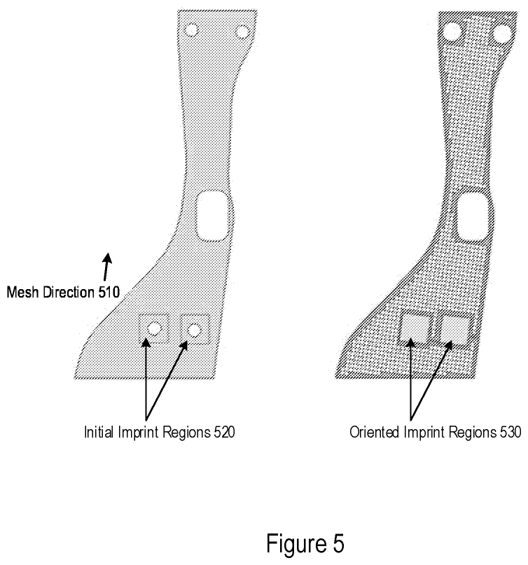

FIG. 5 shows an example orientation of imprint regions to a mesh direction. In the example of FIG. 5, the imprint-based meshing engine 110 may identify a CAD face as a face-of-interest and align any imprinted shapes along a mesh direction 510 for the CAD face. In some instances, the imprint-based meshing engine 110 may itself determine the mesh direction 510 for the CAD face, including a mesh direction 510 specified in a 2D parameter space for CAD faces of 3D CAD models. In doing so, the imprint-based meshing engine 110 may support boundary-aware direction vector computations for CAD faces to determine a mesh direction. The imprint-based meshing engine 110 may determine the mesh direction for a CAD face based on a meshing of the CAD face. For example, prior to, in parallel with, or subsequent to shape imprinting, the imprint-based meshing engine 110 may generate a mesh for the CAD face. This generated mesh may be analyzed by the imprint-based meshing engine 110 to determine the mesh direction for the CAD face.

Mesh direction determinations by the imprint-based meshing engine 110 may be performed in specific ways in various contexts, such as automotive use cases, general mechanical/electrical use, aerospace applications, and more. For automotive cases, an analysis-specific global direction vector may be specified for a 3D CAD model of a car. This global direction vector may specify a collision direction based on a position of impact of the collision analysis. When such a global direction vector Vₓ (e.g., crash direction vector) is not specified for a CAD object, the imprint-based meshing engine 110 may determine a mesh direction for a given CAD face of the CAD object as a natural mesh flow direction vector computed based on a shape of the given CAD face. When such a global direction vector Vₓ is specified for a CAD object, the imprint-based meshing engine 110 may transform the global direction vector Vₓ to a local 2D coordinate system for a given CAD face of the CAD object.

In doing so, the imprint-based meshing engine 110 may translate the global direction vector Vₓ on a per mesh-element basis of a mesh generated for the given CAD face. In some implementations, the imprint-based meshing engine 110 may translate the global direction vector Vₓ to the centroid C (or another selected point) of the i^{th} mesh element of a CAD face f. This translated vector may be referred to as Vₜ. The imprint-based meshing engine 110 may select any point p the translated vector Vₜ and orthogonally project the selected point p on to a point q in the i^{th} mesh element. Then, the imprint-based meshing engine 110 may determine the vector from centroid C to point q as a 3D local crash vector V_{3DcQi} of the i^{th} mesh element of a CAD face f. The imprint-based meshing engine 110 may transform the 3D local crash vector V_{3DcQi} further into a 2D parameter space of the CAD face f to yield V_{2DcQi}, which may be a 2D local crash vector of the i^{th} mesh element of a CAD face f. The 3D and 2D local crash vectors for the CAD face f with n number of mesh elements may be computed by the imprint-based meshing engine 110 via the following functions:

$${V}_{3 Df} = \frac{1}{n} {\sum }_{i = 1}^{n} {V}_{3 DCQi} \qquad ( 1 )$$

$${V}_{2 Df} = \frac{1}{n} {\sum }_{i = 1}^{n} {V}_{2 DCQi} \qquad ( 2 )$$

In these examples, the imprint-based meshing engine 10 determine a 3D local crash vector for the CAD face f as a function of the 3D local crash vectors of the n number of mesh elements that form the CAD face f, for example as an average of a smallest tangential component of the global direction vector Vₓ. For imprint-based mesh generations according to the present disclosure, the imprint-based meshing engine 110 may determine the mesh direction for the 2D parameter space of a CAD face f as the 2D local crash vector V_{2Df} of the CAD face f.

As another example of mesh direction determination, the imprint-based meshing engine 110 may determine a 2D mesh direction for a given CAD face based on a natural shape of a 2D shape of the given CAD face (and in particular, a boundary of the CAD face). To do, the imprint-based meshing engine 110 may flatten a 3D CAD face into 2D and an outer loop of the flattened 2D CAD face is discretized by the imprint-based meshing engine 110 into a set of points (or nodes). The imprint-based meshing engine 110 may then form a closed polygon of n number of nodes discretized from the outer loop. Next, the imprint-based meshing engine 110 may form a 2D convex hull for the polygon, doing in any viable way such as the Gift-Wrap or Andrew algorithms. The formed convex hull of the 2D polygon may be represented by the imprint-based meshing engine 110 as another polygon that is convex and completely encloses the input polygon (in this case, the boundary polygon of the flattened 2D CAD face), and does so without intersecting the input polygon but touching the input polygon at its extremities. Then, the imprint-based meshing engine 110 may compute a minimum oriented bounding box (“MOBB”) of some or all orientations of the formed convex hull (for example using a rotating caliper method).

The imprint-based meshing engine 110 may determine the MOBB of a convex hull as particular oriented bounding box among the considered orientations of the convex hull that has the lowest (e.g., minimum) area. Accordingly, the MOBB of the convex full may encapsulate the convex hull (a 2D polygon) which best encapsulates the 2D polygon representing the CAD face f. The imprint-based meshing engine 110 may determine an angle α as the angle between the X-axis in the local space of the MOBB V_{MOBBx} and the global 2D axis of the CAD face f. The imprint-based meshing engine 110 may determine a vector along this computed angle α as a mesh direction for the CAD face f. For example, the imprint-based meshing engine 110 may determine the X-axis in the local space of the MOBB V_{MOBBx} as the mesh direction for the CAD face f

In any of the ways various ways described herein, the imprint-based meshing engine 110 may determine mesh directions for CAD faces of a CAD object. In the example shown in FIG. 5, the imprint-based meshing engine 110 determines a mesh direction 510 for a CAD face, and may thus orient imprinted shapes and define imprint regions to align with the mesh direction 510. An example of such orientation is shown in FIG. 5 through the initial imprint regions 520 of two box-with-hole type of imprinted shapes and oriented imprint regions 530 defined by orienting the initial imprint regions 520 along the mesh direction 510.

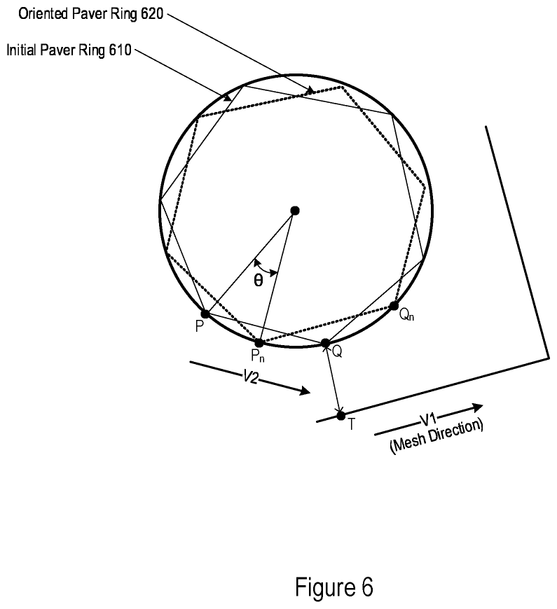

FIG. 6 shows an example orientation of mesh elements of a mesh design to align to a mesh direction of a CAD face. In the example of FIG. 6, the imprint-based meshing engine 110 rotates the mesh elements of a box-with-hole mesh (e.g., constructed as a mesh design selected from a mesh template library 340). The mesh design in the example of FIG. 6 includes six (6) mesh elements that form a paver ring, and with an initial location, position and orientation as depicted through an initial paver ring 610. Upon orienting the initial paver ring 610 along the mesh direction, the resulting location, position and orientation of the paver ring mesh elements (at least boundaries thereof) is shown as the oriented paver ring 620.

For CAD faces in which a global direction vector Vₓ is specified, the imprint-based meshing engine 110 may orient mesh elements of a mesh design (e.g., selected from a mesh template library 340) to align with a 2D local crash vector V_{2Df} of a given CAD face f as the mesh direction for the given CAD face f. The imprint-based meshing engine 110 may determine a 2D angle β between the local crash vector V_{2Df} (mesh direction) and the local X-axis of a 2D parameter space of a given CAD face. Then, the imprint-based meshing engine 110 may transform an imprinted box shape (and thus the imprint region) from local coordinates (Xₗ) to the CAD face-local crash direction coordinates (X_{g}). The imprint-based meshing engine 110 may do so using the relationship X_{g=}T. X₁, in which the transformation matrix T can be specified by the following:

$$T = [ \begin{matrix}cos β & sin β \\ - sin β & cos β\end{matrix} ]$$

For CAD faces in which a global direction vector Vₓ is not specified, the imprint-based meshing engine 110 may orient mesh elements of a mesh design (e.g., selected from a mesh template library 340) to align with the X-axis in the local space of the MOBB V_{MOBBx} of a given CAD face f as the mesh direction for the given CAD face f. Angle α as described herein may represent the angle between the X-axis in the local space of the MOBB V MOBBx (mesh direction) and the local X-axis of a 2D parameter space of a given CAD face. The imprint-based meshing engine 110 may transform an imprinted box shape (and thus the imprint region) from local coordinates (Xₗ) to the CAD face-local crash direction coordinates (X_{g}). The imprint-based meshing engine 110 may do so using the relationship X_{g}=T. Xₗ, in which the transformation matrix T can be specified by the following:

$$T = [ \begin{matrix}cos α & sin α \\ - sin α & cos α\end{matrix} ]$$

Turning again to FIG. 6, in orienting a box-with-hole mesh design along a mesh direction, the imprint-based meshing engine 110 may orient the initial paver ring 610 to be parallel to a tangent vector at the closest point on the box boundary of an imprinted box shape. In order to correct an orientation of the imprinted box near the box boundary so as to reduce stress computation errors, the imprint-based meshing engine 110 may rotate the paver ring (e.g., first layer of mesh elements around a face interior hole) appropriately. The imprint-based meshing engine 110 may do so by rotating a vertex of a circular face loop representing the face interior hole by a parametric offset, and by creating a virtual vertex at the new location. The imprint-based meshing engine 110 may implement such a virtual vertex as a ghost representation of the real geometry vertex. During meshing itself, no node is created by the imprint-based meshing engine 110 at the real vertex location, but is instead created at the virtual vertex location. However, the node may still be associated with the location of the vertex (and not the location of the virtual vertex).

To explain further through FIG. 6, point P shown in FIG. 6 may denote a vertex on circular edge-loop running clockwise inside a box shape imprinted around a face interior hole of a CAD face. The imprint-based meshing engine 110 may first orient the imprinted box shape along a mesh direction of a CAD face, shown as the mesh flow direction V₁ in FIG. 6. Orienting of the box shape may be performed by the imprint-based meshing engine 110 in any of the ways described herein. The imprint based meshing engine 110 may determine mesh control parameters for meshing the imprint region defined by the imprinted box-with-hole shape and the corresponding virtual face. For instance, a user may apply a mesh control parameter on a face interior hole specifying for six (6) nodes. The initial paver ring 610 shown in FIG. 6 may depict a default discretization on the face interior hole by the imprint-based meshing engine 110 with one of the nodes at point P and another one of the nodes at point Q. The imprint-based meshing engine 110 may determine the element edge PQ as the edge of a mesh element closest to the box boundary of the imprinted box shape.

The imprint-based meshing engine 110 may further determine that a node of the initial paver ring 610 located at point Q as being the closest node to the box boundary of the imprinted box shape. Then, the imprint-based meshing engine 110 may project point Q to a nearest box boundary edge at point T. The imprint-based meshing engine 110 may project point Q to the nearest box boundary edge such that the tangent vector to the edge at point T is V₁ (that is, the mesh direction of the CAD face). The imprint-based meshing engine 110 may also determine a direction vector that represents an element edge of the initial paver ring 520 closest to the box boundary. In the example of FIG. 6, this is element edge PQ and the direction vector of element edge PQ is depicted as vector V₂ in FIG. 6. For the initial paver ring 610 to be parallel to the box boundary, the imprint-based meshing engine 110 may rotate the initial paver ring 610 such that vectors V₁ and V₂ are parallel.

In some implementations, the imprint-based meshing engine 110 may represent an angle θ between vectors V₁ and V₂ as follows:

$$θ = {cos}^{- 1} ( \frac{{V}_{1} \cdot {V}_{2}}{\vert {V}_{1} \vert \cdot \vert {V}_{2} \vert} )$$

In this example, vectors V₁ and V₂ may be determined as parallel when the angle θ is 0°. As the initial paver ring 610 for a mesh design typically does not take into account a mesh direction and alignment orientations, it is often the case that the angle θ between vectors V₁ and V₂ (and thus between a particular element edge of the initial paver ring 610 and a mesh direction of a CAD face) are not typically parallel. in order to rotate a closest element edge of the initial paver ring 610 to be parallel to the nearest boundary edge of an imprinted box shape, the imprint-based meshing engine 110 may rotate vertex P to a new location Pₙ. In doing so, the imprint-based meshing engine 110 may rotate the initial paver ring 610 accordingly to a position shown via the oriented paver ring 620 in FIG. 6. Each node/vertex of the initial paver ring 610 is rotated to a new location, as also seen in FIG. 6 by vertex Q of the initial paver ring 610 relocating to position Qₙ on the oriented paver ring 620. Thus, the element edge PₙQₙ, nearest to the boundary of the imprinted box shape now ends at Qₙ instead of Q and the element edge Pₙ Qₙ in the oriented paver ring 620 is parallel to vector V₁ (and are thus oriented along the mesh direction

To rotate the initial paver ring 610 into a position specified by the oriented paver ring 620, the imprint-based meshing engine 110 may rotate the radius vector at vertex P in a direction opposite to the circular edge-loop (counterclockwise) and by a parametric offset S_{off}. The imprint-based meshing engine 110 may determine the required vertex offset as follows:

$${s}_{off} = r \cdot {cos}^{- 1} ( \frac{{V}_{1} \cdot {V}_{2}}{\vert {V}_{1} \vert \cdot \vert {V}_{2} \vert} ) / {l}_{loop}$$

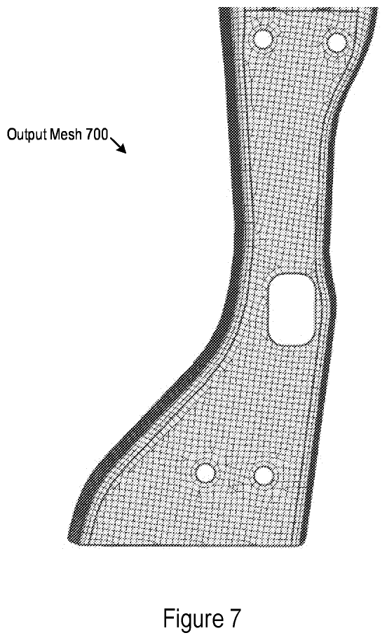

In this example, r may refer to a radius of the face interior hole and lₗₒₒₚ may refer to the length (or perimeter) of the circular edge-loop. In such a manner, the imprint-based meshing engine 110 may relocate node/vertex positions of element edges of mesh elements of mesh designs to properly orient and align with a mesh direction for a CAD face. As such, after offsetting vertices along a circular edge of a face interior hole, the imprint-based meshing engine 110 may correct the orientation of the paver ring of mesh elements to align to a mesh direction. By doing so, mesh elements of an output mesh may now flow along the mesh direction both within imprint regions (e.g., inside a box-with-hole mesh desig0 and in a boolean remainder region outside of the imprint regions. An example of such an output mesh with oriented mesh elements is shown in FIG. 7.

FIG. 7 shows an example of an output mesh 700 in which mesh elements that surround face interior holes align with a mesh direction specified for a CAD face. As seen in the output mesh 700 of Figure, various elements proximate to face interior holes of a CAD face (in imprint regions) are oriented together with other elements in remainder portions of the CAD face. The imprint-based meshing engine 110 may provide a unique capability to orient mesh elements of mesh designs via paver ring orientation, which may result in generation output meshes (like the output mesh 700) that have increasingly structured and patterned mesh elements that that better support FEA simulations.

While many imprint-based meshing features have been described herein through illustrative examples presented through various figures, the CAD face access engine 108 or the imprint-based meshing engine 110 may implement any combination of the imprint-based meshing technology described herein.

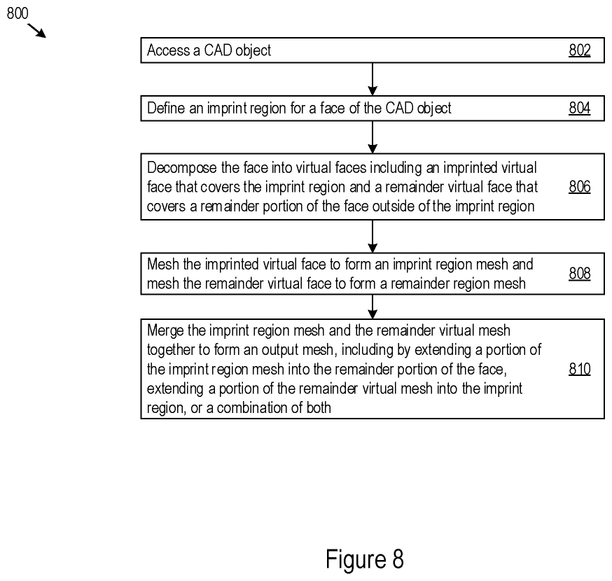

FIG. 8 shows an example of logic 800 that a system may implement to support imprint-based mesh generation. For example, the computing system 100 may implement the logic 800 as hardware, executable instructions stored on a machine-readable medium, or as a combination of both. The computing system 100 may implement the logic 800 via the CAD face access engine 108 and the imprint-based meshing engine 110, through which the computing system 100 may perform or execute the logic 800 as a method to provide any combination of the imprint-based meshing features presented herein. The following description of the logic 800 is provided using the CAD face access engine 108 and the imprint-based meshing engine 110 as examples. However, various other implementation options by computing systems are possible.

In implementing the logic 800, the CAD face access engine 108 may access a CAD object (802). In implementing the logic 800, the imprint-based meshing engine 110 may define an imprint region for a face of the CAD object (804), for example by imprinting a shape on to the CAD face. The imprint-based meshing engine 110 may further decompose the face into virtual faces including an imprinted virtual face that covers the imprint region and a remainder virtual face that covers a remainder portion of the face outside of the imprint region (806) as well as mesh the imprinted virtual face to form an imprint region mesh and mesh the remainder virtual face to form a remainder region mesh (808). In implementing the logic 800, the imprint-based meshing engine 110 may further merge the imprint region mesh and the remainder region mesh together to form an output mesh, including by extending a portion of the imprint region mesh into the remainder portion of the face, extending a portion of the remainder region mesh into the imprint region, or a combination of both (810).

The logic 800 shown in FIG. 8 provides an illustrative example by which a computing system 100 may support imprint-based meshing according to the present disclosure. Additional or alternative steps in the logic 800 are contemplated herein, including according to any of the various features described herein for the CAD face access engine 108, the imprint-based meshing engine 110, or any combinations thereof.

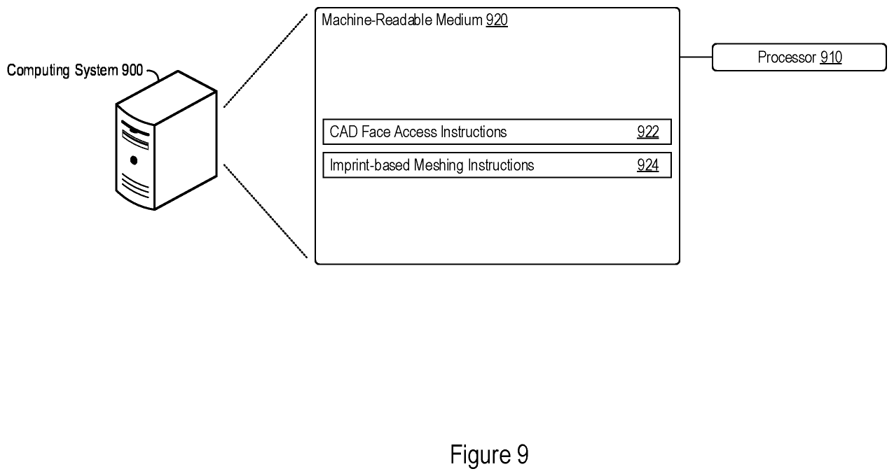

FIG. 9 shows an example of a computing system 900 that supports imprint-based mesh generation. The computing system 900 may include a processor 910, which may take the form of a single or multiple processors. The processor(s) 910 may include a central processing unit (CPU), microprocessor, or any hardware device suitable for executing instructions stored on a machine-readable medium. The computing system 900 may include a machine-readable medium 920. The machine-readable medium 920 may take the form of any non-transitory electronic, magnetic, optical, or other physical storage device that stores executable instructions, such as the CAD face access instructions 922 and the imprint-based meshing instructions 924 shown in FIG. 9. As such, the machine-readable medium 920 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 900 may execute instructions stored on the machine-readable medium 920 through the processor 910. Executing the instructions (e.g., the CAD face access instructions 922 and/or the imprint-based meshing instructions 924) may cause the computing system 900 to perform any aspect of the deformation-based curved mesh generation technology described herein, including according to any of the features of the CAD face access engine 108, the imprint-based meshing engine 110, or combinations of both.

For example, execution of the CAD face access instructions 922 by the processor 910 may cause the computing system 900 to access a CAD object. Execution of the imprint-based meshing instructions 924 by the processor 910 may cause the computing system 900 to define an imprint region for a face of the CAD object, for example by imprinting a shape on to the CAD face. Execution of the imprint-based meshing instructions 924 by the processor 910 may further cause the computing system 900 to decompose the face into virtual faces including an imprinted virtual face that covers the imprint region and a remainder virtual face that covers a remainder portion of the face outside of the imprint region as well as mesh the imprinted virtual face to form an imprint region mesh and mesh the remainder virtual face to form a remainder region mesh. Execution of the imprint-based meshing instructions 924 by the processor 910 may further yet cause the computing system 900 to merge the imprint region mesh and the remainder region mesh together to form an output mesh, including by extending a portion of the imprint region mesh into the remainder portion of the face, extending a portion of the remainder region mesh into the imprint region, or a combination of both.

Any additional or alternative imprint-based meshing features as described herein may be implemented via the CAD face access instructions 922, imprint-based meshing instructions 924, or a combination of both.

The systems, methods, devices, and logic described above, including the CAD face access engine 108 and the imprint-based meshing engine 110, may be implemented in many different ways in many different combinations of hardware, logic, circuitry, and executable instructions stored on a machine-readable medium. For example, the CAD face access engine 108, the imprint-based meshing engine 110, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the CAD face access engine 108, the imprint-based meshing engine 110, or combinations thereof.

The processing capability of the systems, devices, and engines described herein, including the CAD face access engine 108 and the imprint-based meshing engine 110, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
accessing a computer-aided design object;
defining an imprint region for a face of the CAD object;
decomposing the face into virtual faces, including an imprinted virtual face that covers the imprint region and a remainder virtual face that covers a remainder portion of the face outside of the imprint region;
meshing the imprinted virtual face to form an imprint region mesh and meshing the remainder virtual face to form a remainder region mesh; and
merging the imprint region mesh and the remainder region mesh together to form an output mesh, including by extending a portion of the imprint region mesh into the remainder portion of the face, extending a portion of the remainder region mesh into the imprint region, or a combination of both.

2. The method of claim 1, comprising meshing the imprinted virtual face at a finer mesh element size than the meshing of the remainder virtual face.

3. The method of claim 1, comprising meshing the imprinted virtual face at a local mesh element size specified for the imprint region and meshing the remainder virtual face at a global mesh element size specified for the CAD object.

4. The method of claim 1, further comprising defining the imprint region as a box-with-hole type of imprint region; and
wherein meshing the imprinted virtual face comprises selecting a mesh design from a mesh template library in order to mesh the imprinted virtual face.

5. The method of claim 1, wherein defining the imprint region comprises orienting the imprint region to a mesh direction specified for the CAD object.

6. The method of claim 1, wherein defining the imprint region comprises imprinting a shape on to the face of the CAD object.

7. The method of claim 6, comprising imprinting the shape on the face of the CAD object based on imprint parameters that specify a location of the face to imprint the shape, a shape type, and a shape size.

8. A system comprising:
a processor; and
a non-transitory machine-readable medium comprising instructions that, when executed by a processor, cause a computing system to:
access a computer-aided design (CAD) object;
define an imprint region for a face of the CAD object;
decompose the face into virtual faces, including an imprinted virtual face that covers the imprint region and a remainder virtual face that covers a remainder portion of the face outside of the imprint region;
mesh the imprinted virtual face to form an imprint region mesh and mesh the remainder virtual face to form a remainder region mesh; and
merge the imprint region mesh and the remainder region mesh together to form an output mesh, including by extending a portion of the imprint region mesh into the remainder portion of the face, extending a portion of the remainder region mesh into the imprint region, or a combination of both.

9. The system of claim 8, wherein the instructions, when executed, cause the computing system to mesh the imprinted virtual face at a finer mesh element size than the meshing of the remainder virtual face.

10. The system of claim 8, wherein the instructions, when executed, cause the computing system to:
mesh the imprinted virtual face at a local mesh element size specified for the imprint region; and
mesh the remainder virtual face at a global mesh element size specified for the CAD object.

11. The system of claim 8, wherein the instructions, when executed, further cause the computing system to define the imprint region as a box-with-hole type of imprint region; and
wherein the instructions, when executed, cause the computing system to mesh the imprinted virtual face by selecting a mesh design from a mesh template library in order to mesh the imprinted virtual face.

12. The system of claim 8, wherein the instructions, when executed, cause the computing system to define the imprint region by orienting the imprint region to a mesh direction specified for the CAD object.

13. The system of claim 8, wherein the instructions, when executed, cause the computing system to define the imprint region by imprinting a shape on to the face of the CAD object.

14. The system of claim 13, wherein the instructions, when executed, cause the computing system to imprint the shape on the face of the CAD object based on imprint parameters that specify a location of the face to imprint the shape, a shape type, and a shape size.

15. A non-transitory machine-readable medium comprising instructions that, when executed by a processor, cause a computing system to:
access a computer-aided design (CAD) object;
define an imprint region for a face of the CAD object;
decompose the face into virtual faces, including an imprinted virtual face that covers the imprint region and a remainder virtual face that covers a remainder portion of the face outside of the imprint region;
mesh the imprinted virtual face to form an imprint region mesh and mesh the remainder virtual face to form a remainder region mesh; and
merge the imprint region mesh and the remainder region mesh together to form an output mesh, including by extending a portion of the imprint region mesh into the remainder portion of the face, extending a portion of the remainder region mesh into the imprint region, or a combination of both.

16. The non-transitory machine-readable medium of claim 15, wherein the instructions, when executed, cause the computing system to:
mesh the imprinted virtual face at a local mesh element size specified for the imprint region; and
mesh the remainder virtual face at a global mesh element size specified for the CAD object.

17. The non-transitory machine-readable medium of claim 15, wherein the instructions, when executed, further cause the computing system to define the imprint region as a box-with-hole type of imprint region; and
wherein the instructions, when executed, cause the computing system to-mesh the imprinted virtual face by selecting a mesh design from a mesh template library in order to mesh the imprinted virtual face.

18. The non-transitory machine-readable medium of claim 15, wherein the instructions, when executed, cause the computing system to define the imprint region by orienting the imprint region to a mesh direction specified for the CAD object.

19. The non-transitory machine-readable medium of claim 15, wherein the instructions, when executed, cause the computing system to define the imprint region by imprinting a shape on to the face of the CAD object

20. The non-transitory machine-readable medium of claim 19, wherein the instructions, when executed, cause the computing system to imprint the shape on the face of the CAD object based on imprint parameters that specify a location of the face to imprint the shape, a shape type, and a shape size.
